(19) United States
(12) Patent Application Publication
(10) Pub. No.: US 2008/0172158 A1
(43) Pub. Date: Jul. 17, 2008

(54) Air-bag deployment system

(75) Inventor: Mineyuki Oishi, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/882,338

(22) Filed: Aug. 1, 2007

(30) Foreign Application Priority Data
Sep. 28, 2006 (JP) 2006-263728

(51) Int. Cl. B60R 21/01; B60R 21/16

(52) U.S. Cl. 701/45

(57) ABSTRACT

An air-bag deployment system includes a first acceleration sensor provided in a front side portion of a vehicle body, a second acceleration sensor provided in a passenger compartment, an air-bag deployment judging device and an air-bag deployment device for deploying an air bag. The air-bag deployment judging device executes a first deployment judgment using primarily the first acceleration signal to output a deployment allowance signal ON and a second deployment judgment using primarily the second acceleration signal to output a deployment signal ON. An allowance judging part receives data abnormality signal from a data abnormality judging part and outputs a deployment allowance signal ON when the judging part receives the data abnormality signal ON. An ignition signal ON is outputted from an AND logical operator when both of the deployment allowance signal and the deployment signal are ON.

### BACKGROUND OF THE INVENTION

1. Field of the Invention

The present invention relates to an air-bag deployment system which controls deployment of an air bag according to judgments based on accelerations detected by a first acceleration sensor provided in a crashable zone in front of a passenger compartment and a second acceleration sensor provided in the passenger compartment when a motor vehicle with the system collides with an object such as another motor vehicle and a structure object, and also relates to an air-bag deployment control method used therein.

2. Description of the Related Art

A conventional air-bag deployment system of this kind is disclosed in Japanese patent laid-open publication No 2001-10441. This conventional air-bag deployment system has a first collision detection unit provided in a crashable zone of a front side portion of a motor-vehicle body, a second collision detection unit provided in a passenger compartment, and an air-bag deployment device for igniting two inflators to deploy an air bag based on results of AND operations of collision signals outputted from the first and second collision detection devices at an initial stage and at its subsequent stage of the collision. Ignition timings of the two inflators are staggered in order to control deployment of the air bag based on the results of the AND operations, thereby regulating expansion of the air bag at an optimum speed. In addition, the control of the air-bag deployment by using the AND operations can avoid misjudgments of collisions. Another air-bag deployment system is shown in FIG. 9, not laid open, which is devised by the inventor of the present invention. This system is able to regulate expansion speed of an air bag by using only one inflator so that the air bag can deploy at an appropriate speed.

The system 100 includes a first acceleration sensor 210, a second acceleration sensor 310, a collision judging device 300 and an air-bag deploying device 400. The first acceleration sensor 210 is contained in a crash detecting unit 200, being provided on a front side portion of a not-shown vehicle body so that it can detect acceleration of a motor vehicle when it collides with an object such as another motor vehicle and a structure object near a road. The second acceleration sensor 310 is provided in a passenger compartment, for example, in a collision judging device 300 installed therein. The collision judging device 300 has a trigger judging part 320 and an arithmetic processing unit 340 including a deployment judging part 34A, an acceleration level judging part 34B and an AND logical operator 34C. The air-bag deploying device 400 has a not shown inflator for deploying a not-shown air bag.

The trigger judging part 320 receives a second acceleration signal outputted from the second acceleration sensor 310 to judge whether the detected second acceleration is larger than a predetermined one, and then outputs a trigger signal to the arithmetic processing unit 340 when its judgment result is YES (a crash). When the arithmetic processing unit 340 receives the trigger signal, it starts the judgment on deployment of the air bag. The deployment judging part 34A receives a first acceleration signal outputted from the sensors 210 and the second acceleration signal outputted from the second acceleration sensor 310, and judges the collision to output a deployment signal. The acceleration level judging part 34B receives the first acceleration signal to judge whether the detected first acceleration is larger than an acceleration threshold value, which is set to be constant, and output a level judgment signal when the judgment level is YES. The AND logical operator 34C outputs an ignition signal to ignite a squib of the inflator of the air-bag deployment unit 400 when the element 34C receives the deployment signal and the level judgment signal.

The above known conventional air-bag deployment system and the above-described unknown system proposed by the inventor, however, encounter a problem in that the air bag cannot be deployed in a case where the first collision detection unit (similarly, the first acceleration sensor 210) or its wire fails to cause abnormality in data information on the first acceleration temporally or permanently in the event of the collision. Note that the first collision detection unit, the first acceleration sensor, and their wires are damaged in a frontal collision more easily than the second collision detection unit, the second acceleration sensor and their wires, because the former is provided in a crashable zone of the vehicle body, namely the front side portion thereof, while the latter is provided in the passenger compartment.

Specifically, the system shown in FIG. 9 behaves as follows when the abnormality of the data information outputted from the first acceleration sensor 210 occurs in the event of the collision. FIG. 10 shows its example of is time chart, with a horizontal axis of time t and a vertical axis of intensities of various signals, where a first part (a) in FIG. 10 shows the second acceleration signal inputted to the arithmetic processing unit 340, a second part (b) thereof shows the first acceleration signal inputted to the arithmetic processing unit 340, a third part (c) thereof shows the level judgment signal outputted from the acceleration level judging part 34B, a fourth part (d) thereof shows the deployment signal outputted from the deployment judging part 34A, and a fifth part (e) thereof shows the ignition signal outputted from the AND logical operator 34C.

In this example, the first acceleration sensor 210 starts to output the first acceleration signal of collision at time to. Then, the first acceleration signal increases with oscillation.

On the other hand, the second acceleration sensor 310 also starts to output the second acceleration signal of the collision at the almost same time of time t₀, with very small delay, and then the second acceleration signal increases. At time t₁, the trigger judging part 320 judges that the second acceleration signal exceeds the predetermined one, and outputs the trigger signal ON, which causes the arithmetic processing unit 340 to start an air-bag deployment judging process.

At time t₂, the data information of the first acceleration sensor 210 happens to be abnormal due to damage of the first acceleration sensor 210 and/or its wire. As shown the second part (b) in FIG. 10, the first acceleration signal does not reach the acceleration threshold value TH/L by the time t₂, and becomes OFF after this time t₂. Consequently, the acceleration level judging part 34B judges the level judgment signal to be OFF as shown in the third part (c) in FIG. 10.

The deployment judging part 34A calculates an integral value of the second acceleration signal from the time t₀, and at time t₃ it judges that the integral value exceeds a speed threshold value, then outputting the deployment signal ON to the AND logical operator 34C as shown in the fourth part (d) in FIG. 10.

The AND logical operator 34C receives the deployment signal ON and the level judgment signal OFF, and accordingly keeps the ignition signal to be OFF until termination time T₄, namely an end of the deployment judging process as shown in the fifth part (e) in FIG. 10. Therefore, the air bag cannot be deployed, although the motor vehicle is crashed in the collision.

It is, therefore, an object of the present invention to provide an air-bag deployment system which overcomes the foregoing drawbacks and can decrease misjudgment on collision as much as possible and increase the opportunity to deploy an air bag in a case of the collision where data information outputted from a first acceleration sensor, which is provided at a front side portion of a motor vehicle, becomes abnormal in the collision.

It is another object of the present invention to provide an air-bag deployment control method which overcomes the foregoing drawbacks and can decrease misjudgment on collision as much as possible and increase the opportunity to deploy an air bag in a case of the collision where data information outputted from a first acceleration sensor, which is provided at a front side portion of a motor vehicle, becomes abnormal in the collision.

### SUMMARY OF THE INVENTION

According to a first aspect of the present invention there is provided an air-bag deployment system including a first acceleration sensor, a second acceleration sensor, an air-bag deployment judging device including a data abnormality judging part and an allowance judging part, and an air-bag deployment device. The first acceleration sensor is provided in a front side portion of a vehicle body and detects acceleration to output a first acceleration signal, and the second acceleration sensor is provided in a passenger compartment and detects acceleration to output a second acceleration signal. The air-bag deployment judging device receives the first and second acceleration signals and executes a first deployment judgment that uses primarily the first acceleration signal to output a deployment allowance signal and a second deployment judgment that uses primarily the second acceleration signal to output a deployment signal. The air-bag deployment judging device executing an AND operation of the deployment allowance signal and the deployment signal so that an ignition signal ON is outputted when both of the deployment allowance signal and the deployment signal are ON. The air-bag deployment device receives the ignition signal and deploys an air bag when the ignition signal is ON. The data abnormality judging part monitors the first acceleration signal and outputs a data abnormality signal ON when the data abnormality judging part judges data information on the first acceleration signal to be abnormal. The allowance judging part receives the data abnormality signal and outputs the deployment allowance signal ON when the allowance judging part receives the data abnormality signal ON.

According to a second aspect of the present invention there is provided an air-bag deployment control method including detecting acceleration to output a first acceleration signal by using a first acceleration sensor provided in a front side portion of a vehicle body; detecting acceleration to output a second acceleration signal by using a second acceleration sensor provided in a passenger compartment; receiving the first and second acceleration signals and executing a first deployment judgment that uses primarily the first acceleration signal to output a deployment allowance signal and a second deployment judgment that uses primarily the second acceleration signal to output a deployment signal, by an air-bag deployment judging device; monitoring the first acceleration signal and outputting a data abnormality signal ON when the data abnormality judging part judges data information on the first acceleration signal to be abnormal, by a data abnormality judging part of the air-bag deployment judging device; outputting the deployment allowance signal ON when the data abnormality signal is ON; and executing an AND operation of the deployment allowance signal and the deployment signal so that an ignition signal ON is outputted to an air-bag deployment device when both of the deployment allowance signal and the deployment signal are ON, by the air-bag deployment judging device.

### BRIEF DESCRIPTION OF THE DRAWINGS

The objects, features and advantages of the present invention will become apparent as the description proceeds when taken in conjunction with the accompanying drawings, in which:

FIG. 1 is a schematic diagram showing a motor vehicle which is equipped with an air-bag deployment system of a first embodiment according to the present invention when the motor vehicle is on the point of colliding with an object located in front thereof;

FIG. 2 is a diagram showing control blocks of the air-bag deploying system of the first embodiment;

FIG. 3 is a time chart showing an example of a behavior of the air-bag deployment system shown in FIGS. 1 and 2 in the event of collision where data information obtained from a first acceleration sensor is normal during the collision;

FIG. 4 is a time chart showing an example of the behavior of the air-bag deployment system shown in FIGS. 1 and 2 in the event of collision when the data information becomes abnormal and a first acceleration signal is kept falling below an acceleration threshold value during the collision;

FIG. 5 is time chart showing an example of the behavior of the air-bag deployment system shown in FIGS. 1 and 2 in the event of collision when the data information becomes abnormal and then becomes normal again during the collision;

FIG. 6 is a time chart showing another example of the behavior thereof in the event of the collision when the data information becomes abnormal and then becomes normal again during the collision;

FIG. 7 is a time chart showing a further example of the behavior thereof in the event of the collision when the data information becomes abnormal and then becomes normal again during the collision;

FIG. 8 is a time chart showing another example of the behavior thereof in the event of the collision when;

FIG. 9 is a diagram showing control blocks of an air-bag deployment judging part used in an unknown air-bag deployment system which is improved by the inventor; and

FIG. 10 is a time chart showing an example of an air-bag deployment judging process which is executed by the air-bag deployment judging part in a case where data information obtained from a first acceleration sensor becomes abnormal in the event of collision.

### DETAILED DESCRIPTION OF THE PREFERRED EMBODIMENTS

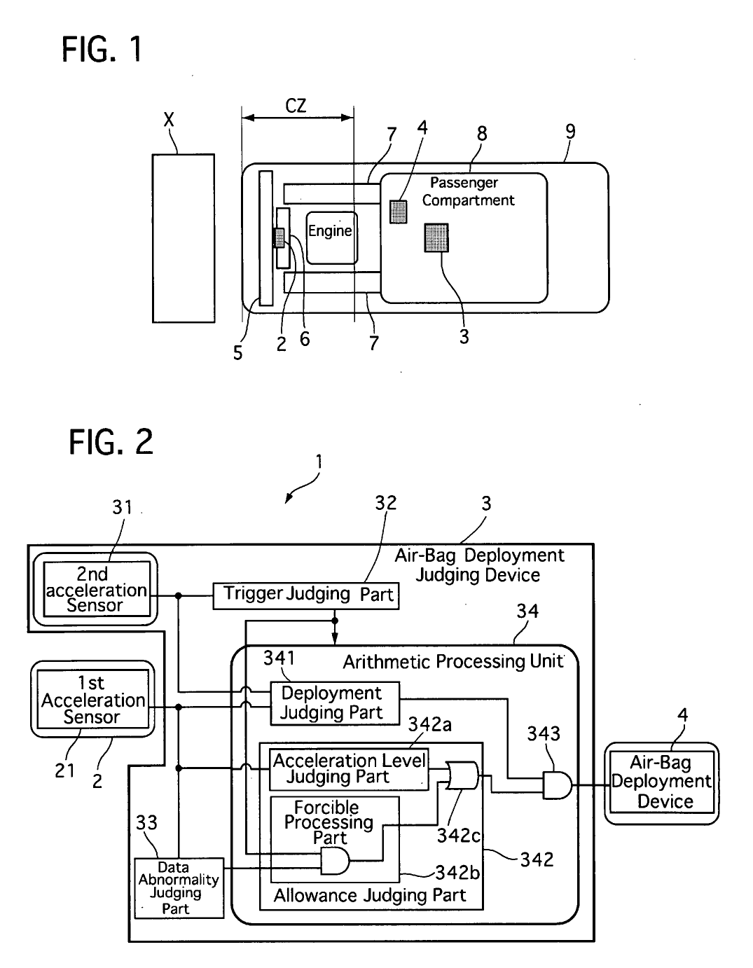

Throughout the following detailed description, similar reference characters and numbers refer to similar elements in all figures of the drawings, and their descriptions are omitted for eliminating duplication. Referring to FIGS. 1 and 2 of the drawings, there is shown a preferred embodiment of an air-bag deployment system according to the present invention.

The air-bag deployment system 1 includes a first acceleration sensor 21, an air-bag deployment judging device 3 containing a second acceleration sensor 31, and an air-bag deployment device 4.

As shown in FIG. 1, a crash detecting unit 2 containing the first acceleration sensor 21 is provided in a crashable zone CZ of a front side portion of a vehicle body 9. For example, the crash detecting unit 2 is mounted on a bumper armature 5 or on a radiator 6, which are supported by front side portions of right and left side members in this embodiment. Incidentally, the crashable zone CZ is provided in front of a passenger compartment 8 so that it can absorb a crash impact by being crashed in the event of collision. The unit 2 contains an electronic circuit and the first acceleration sensor 21, which is configured to detect deceleration of the crash zone CZ and output a first acceleration signal to the deployment judging unit 3.

The second acceleration sensor 31 is installed in the air-bag deployment judging device 3 which is fixed on a front central portion of a floor in the passenger compartment 8. The second acceleration sensor 31 is configured to detect the deceleration at the passenger compartment 8 and output a second acceleration signal to the deployment judging device 3. The second acceleration signal delays relative to the first acceleration signal, notably in a low-speed fontal crash, while the former is more stable than the latter. In this embodiment, the second acceleration sensor 31 can also function as a safing sensor, which is used for avoiding misjudgment of collision.

The air-bag deployment judging unit 3 has a trigger judging part 32, a data abnormality judging part 33 and an arithmetic processing unit 34. The arithmetic processing unit 34 includes a deployment judging part 341, an allowance judging part 342 consisting of an acceleration level judging part 342a, a forcible processing part 342b and an OR logical operator 342c, and an AND logical operator 343. Incidentally, the allowance judging part 342 executes a first deployment judgment of the present invention, and the deployment judging part 341 executes a second deployment judgment of the present invention. The first and second deployment judgments will be later described.

The trigger judging part 32 is electrically connected to the second acceleration sensor 31 and the arithmetic processing unit 34. The trigger judging part 32 receives the second acceleration signal to judge whether it is larger than a predetermined acceleration value, and then outputs a trigger signal ON to the arithmetic processing unit 34 when its judgment result is YES. The trigger signal ON causes the arithmetic processing unit 34 to start its air-bag deployment judging process.

The data abnormality judging part 33 is electrically connected to the first acceleration sensor 21 and the forcible processing part 342b. It monitors the first acceleration signal at an initial stage when an ignition key is turned on, at a predetermined intervals during a running stage of the system, and at an end stage when the ignition key is turned off. A data abnormality signal ON is outputted from the data abnormality judging part 33 to the forcible processing part 342b when the judging part 33 judges data information on the first acceleration signal to be abnormal.

The deployment judging part 341 is electrically connected to the first and second acceleration sensors 21 and 32 and the AND logical operator 343. The deployment judging part 341 receives the first and second acceleration signals to judge deployment of the air bag based thereon. Many different deployment judging algorithms are proposed and used, and, in this embodiment, for example an integral value of the deceleration detected by the second acceleration sensor 31 is calculated from the beginning of the collision, where this integral value corresponds to a variation of speed in the collision. When it is judged that the integral value exceeds a speed threshold value, the deployment signal ON is outputted from the deployment judging part 341 to the AND logical operator 343. Specifically, the integral value in low-speed collision is obtained by using superposition integral processing of differences between the acceleration (deceleration) and a predetermined value. The integral value in medium-speed collision is obtained by using interval integral processing of the acceleration (deceleration), and the integral value in high-speed collision is obtained by using a differential processing of the acceleration (deceleration). The deployment signal corresponds to a result of the second deployment judgment.

In addition, the deployment judging part 341 is configured to judge the deployment of the air bag based on the first acceleration signal, and outputs the deployment signal when the first acceleration signal meets a predetermined condition. That is, the first acceleration signal is also used for increasing reliability of the deployment judgment of the air bag in the event of the collision, because the first acceleration senor 21 can detect a crash earlier than the second acceleration sensor 31 although the second acceleration signal is more stable than the first acceleration signal.

The acceleration level judging part 342a is electrically connected to the first acceleration sensor 21 and the OR logical operator 342c. The acceleration level judging part 342a receives the first acceleration signal to judge whether the signal is larger than an acceleration threshold value TH/L. An acceleration level judgment signal ON is outputted therefrom to the OR logical operator 342c when the judgment result is YES. In the acceleration level judging part 342a, once the judgment result becomes YES, the judging part 342a starts latch-count and the level judgment signal is outputted, being kept ON during a predetermined latch time GL, although the first acceleration signal becomes smaller after its judgment time, as long as it is in the latch time GL. The level judgment signal is shifted to be OFF after the latch time GL, as long as the signal does not exceed the acceleration threshold value TH/L again in and after the latch time GL. When the first acceleration signal exceeds the acceleration threshold value TH/L again in the latch time GL, the judging part 342a resets the latch-time and starts to count it, keeping outputting the acceleration level signal ON for another latch time GL.

The forcible processing part 342b employs an AND operator element, which is electrically connected to the trigger judging part 341, the data abnormality judging part 33 and the OR logical operator 342c. The forcible processing part 342b receives the trigger signal and the data abnormality signal to output a forcible deployment signal ON to the OR logical operator 342c when the both signals are ON.

The OR logical operator 342c is electrically connected to the acceleration level judging part 342a, the forcible processing part 342b and the AND logical operator 343. The OR logical operator 342c outputs a deployment allowance signal ON when it receives at least one of the acceleration level signal ON and the forcible deployment signal ON. The deployment allowance signal corresponds to a result of the first deployment judgment.

The AND logical operator 343 is electrically connected to the deployment judging part 341 and the OR logical operator 342c. The AND logical operator 343 outputs an ignition signal ON when it receives the acceleration level signal ON and the deployment allowance signal ON.

The air-bag deployment device 4 is installed in a steering wheel pad with a not-shown air bag. The air-bag deployment device 4 has a not-shown squib, to be ignited when the ignition signal becomes ON, and a not-shown enhancer for generating a gas to deploy the air bag.

The operation of the air-bag deployment system of the embodiment will be described.

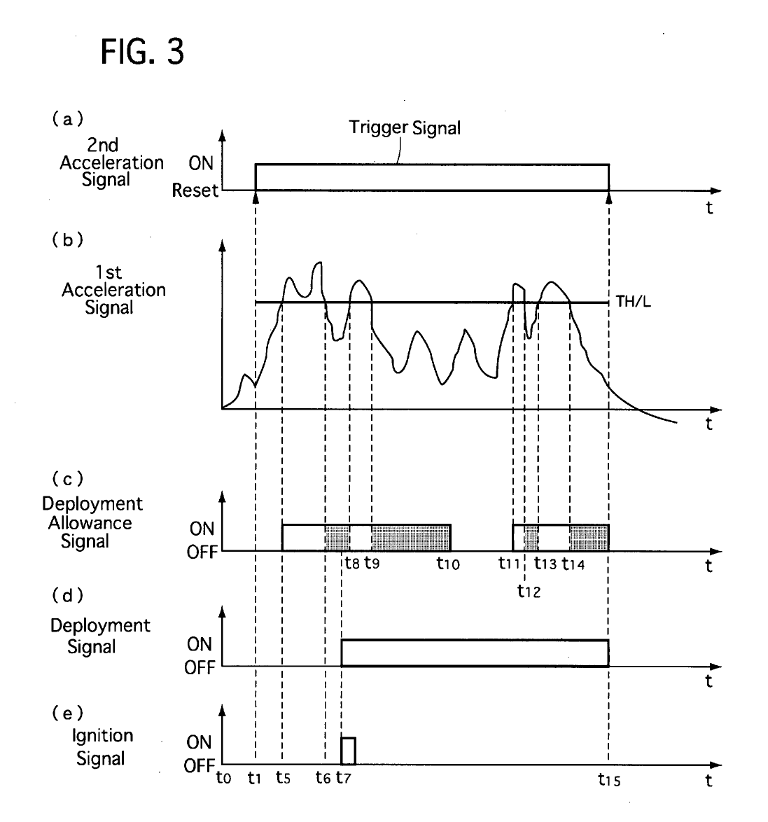

First, the operation executed when all parts of the air-bag deployment system are in a normal state will be described. FIG. 3 shows its time chart when a frontal crash occurs.

When the motor vehicle collides with an object X, located in front thereof and shown in FIG. 1, at time to, a crash impact acts on the front side portion of the vehicle body 9, so that its crashable zone CZ begins to crash and absorb the impact. This crash impact is detected immediately by the first acceleration sensor 21, and this detected first acceleration signal starts to increase from the time to, as shown in a second part (b) in FIG. 3. This first acceleration signal is sent to the deployment judging part 341, the acceleration level judging part 342a and the data abnormality judging part 33.

The crash impact is transmitted to the passenger compartment 8 through the side members 7 and others, where it is also detected by the second acceleration sensor 31 and the second acceleration signal is sent to the trigger judging part 32 and the deployment judging part 341.

In the crash, the second acceleration signal exceeds the predetermined acceleration value, so that the trigger judging part 32 starts to output the trigger signal ON from time t1, as shown in a first part (a) in FIG. 3, to the arithmetic processing unit 34. This trigger signal ON causes the arithmetic processing unit 34 to start its air-bag deployment judging process.

The first acceleration signal increases and reaches the acceleration threshold level TH/L at time t₅, as shown in the second part (b), where the acceleration level judging part 341 outputs the acceleration level signal ON to the OR logical operator 342a, where the acceleration signal corresponds to the deployment allowance signal in this normal operation as shown in a third part (c) in FIG. 3. The first acceleration signal oscillates, for example as shown in the second part (b), so that it exceeds the acceleration threshold value TH/L between time t₅ and time t₆, between time t₈ and time t₉, between time t₁₁ and time t₁₂ and between time t₁₃ and time t₁₄, while it falls below the threshold value TH/L between time t₆ and time t₈, between time t₉ and time t₁₁, between time t₁₂ and time t₁₃ and between t₁₄ and time t₁₅. This causes the acceleration level signals ON between time t₅ and t₁₀ and between t₁₁ and t₁₅, due to a latch-count process. Note that an area between the time t₉ and the time too corresponds to the latch time GL. The deployment allowance signals become ON in hatched areas shown in the third part (c) due to the latch-count process, although the first acceleration signal falls below the acceleration threshold level TH/L in the hatched areas.

On the other hand, the deployment judging part 341 keeps judging based on the second acceleration signal whether its integral value exceeds the speed threshold value or not. At time t₇, its judgment result becomes YES, and the deployment judging part 341 outputs the deployment signal ON to the AND logical operator 343 from the time t₇ to the time t₁₅ as shown in a fourth part (d) in FIG. 3.

The data abnormality judging part 33 receives the first acceleration signal, and judges no abnormality of the data information thereon in this air-bag deployment process. Therefore, the data abnormality signal outputted from the data abnormality judging part 33 is kept OFF, causing the forcible processing part 342b to output the forcible deployment signal OFF to the OR logical operator 342c.

From the time t₇, the OR logical operator 342c receives the deployment signal ON and the forcible deployment signal OFF, and accordingly outputs the allowance judgment signal ON to the AND logical operator 343.

Then, the AND logical operator 343 receives the level judgment signal ON and the deployment allowance signal ON, and then outputs the ignition signal ON to the air-bag deployment device 4 at the time t₇ as shown in a fifth part (d) in FIG. 3. The ignition signal ON ignites the squib of the air-bag deployment device 4 to deploy the air bag for, protecting a driver from a crash damage.

Next, the operations executed in the air-bag deployment system of the embodiment in various cases where the data information on the first acceleration signal is abnormal during collision will be described. In these operations, different operation-parts thereof will be described and descriptions of their similar ones will be omitted to eliminate duplications.

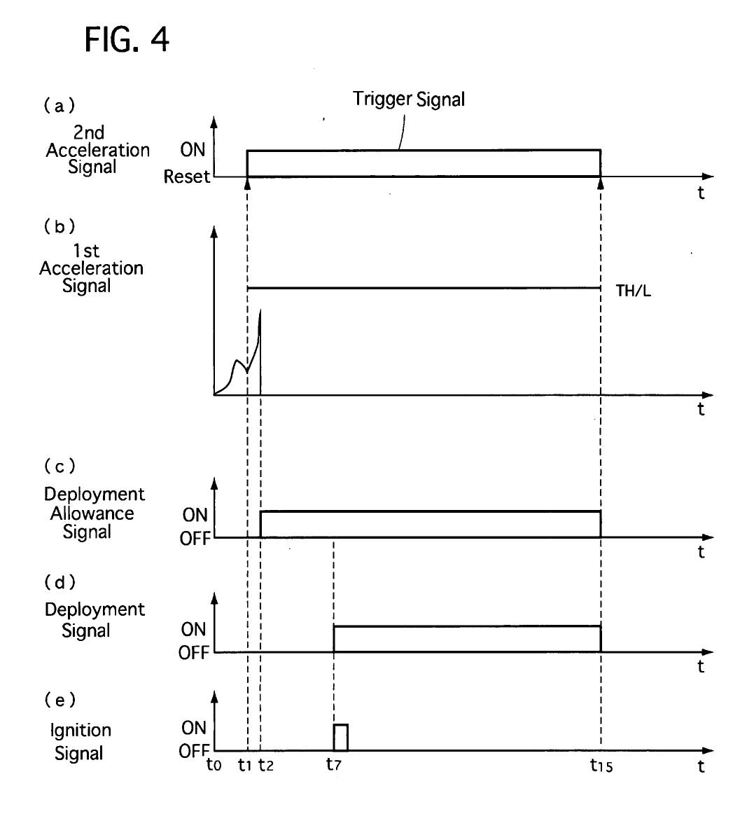

A time chart of a second example of the operation of the air-bag deployment system is shown in FIG. 4, where the data information becomes abnormal and the first acceleration signal never reach the acceleration threshold value TH/L during the collision.

At the time ti, the trigger judging part 32 judges that the first acceleration signal exceeds the predetermined acceleration value, and then outputs the trigger signal ON to the arithmetic processing unit 34 and the forcible processing part 342b thereof, as shown in a first part (a) in FIG. 4.

At the time t₂, the data abnormality judging part 33 judges abnormality of the data information on the first acceleration signal, and outputs the data abnormality signal ON to the forcible processing part 342b. Note that the first acceleration signal is kept below the acceleration threshold value TH/L between the time to and the time t₂ and after t₂, as shown in a second part (b) in FIG. 4.

Consequently, the forcible processing part 342b outputs the forcible deployment signal ON to the OR logical operator 343 from the time t₂ to the time t₁₅, as shown in a third part (c) in FIG. 4, because it receives the data abnormality signal ON and the trigger signal ON at the time t₂.

The level judgment signal outputted from the acceleration level judging part 342a is kept OFF, because the firs acceleration signal is kept being smaller than the acceleration threshold value TH/L during the collision.

On the other hand, the deployment judging part 341 calculates the integral value based on the second acceleration signal from the time to, and judges that the second acceleration signal exceeds the speed threshold value at time t₇. From the time t₇ to the time t₁₅, the deployment signal ON is outputted therefrom to the AND logical operator 343, as shown in a fourth part (d) in FIG. 4.

Therefore, the OR logical operator 342c receives the level judgment signal ON and the level judgment signal OFF to output the deployment allowance signal ON to the AND logical operator 343.

The AND logical operator 343 outputs the ignition signal ON to the air-bag deployment device 4 at the time t₇ as shown in a fifth part (e) in FIG. 4, because the deployment signal and the deployment allowance signal are ON. The ignition signal ON ignites the squib of the air-bag deployment device 4 to deploy the air bag for protecting the driver from a crash damage.

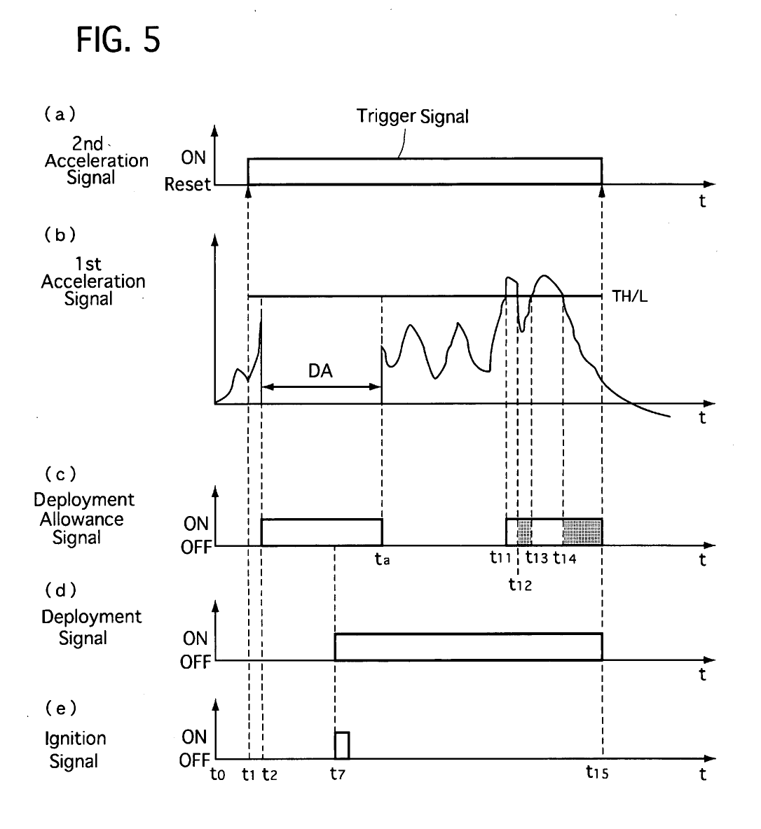

A time chart of a third example of the operation of the air-bag deployment system is shown in FIG. 5. In this example, the first acceleration signal is similar to that in FIG. 3 except that the data information becomes abnormal for a period DA from the time t₂ to tₐ and then it recovers normally during the collision. Note that the first acceleration signal is kept below the acceleration threshold value TH/L from the time T₀ to t₁₁, including the period DA.

At time t₂, the data abnormality judging part 33 judges the abnormality of the first acceleration signal and outputs the data abnormality signal ON to the allowance judging part 342b. Consequently, the deployment allowance signal ON starts to be outputted as shown in a third part (c) in FIG. 5.

At the time tₐ, the data abnormality judging part 33 judges the data information to be normal again and outputs the data abnormality signal OFF to the allowance judging part 342b. Consequently, the deployment allowance signal is changed to be OFF at the time tₐ.

From the time tₐ to t₁₁, the first acceleration signal is below the threshold value TH/L, and accordingly the deployment allowance signal is kept OFF during this period. From the time t₁₁ to the time t₁₅, the deployment allowance signal is similar to that in FIG. 3.

On the other hand, the deployment judging part 341 calculates the integral value based on the second acceleration signal and judges the deployment of the air bag at the time t₇, similarly to that in FIG. 3, which is between the time t₂ and the time tₐ where the deployment allowance signal is ON. The deployment signal ON is outputted from the time t7 to the time t15 as shown in a fourth part (d) in FIG. 5.

Therefore, the AND logical operator 343 outputs the ignition signal ON to the air-bag deployment device 4. The ignition signal ON ignites the squib of the air-bag deployment device 4 to deploy the air bag for protecting the driver from a crash damage.

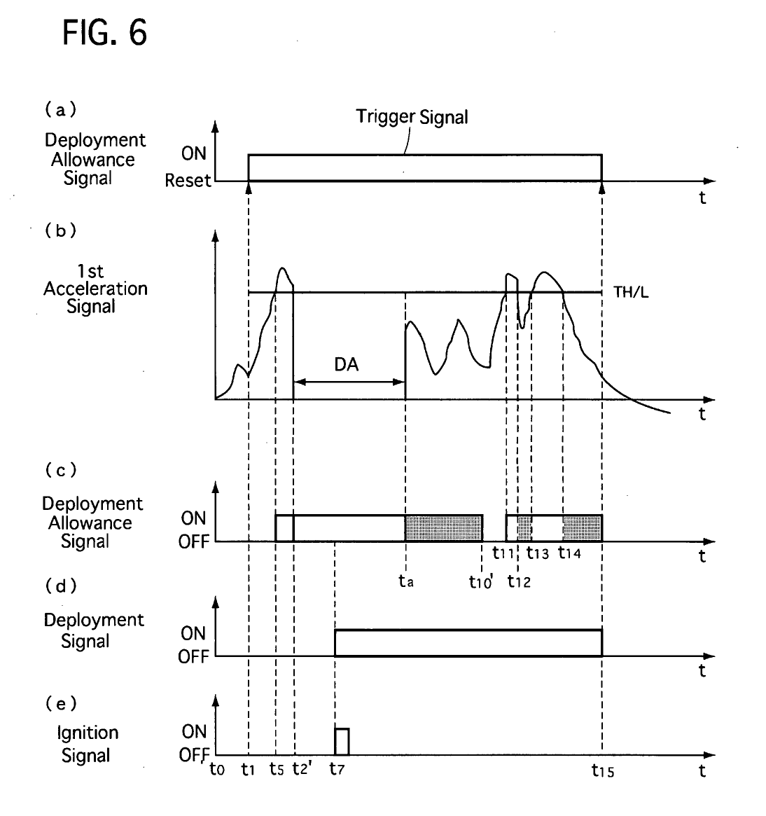

A time chart of a fourth example of the operation of the air-bag deployment system is shown in FIG. 6. In this example, the first acceleration signal is similar to that in FIG. 3 except that the data information becomes abnormal for the period DA from the time t_{2′}, to t₈ and then it recovers normal at the time tₐ during the collision. Note that the first acceleration signal exceeds the threshold value TH/L at the time t₅ and then the abnormality of the data information occurs at the time t_{2′} where the first acceleration signal is still over the threshold value TH/L.

At the time t₅, the first acceleration signal exceeds the threshold value TH/L as shown in a second part (b) in FIG. 6, and the deployment judging part 342a outputs the deployment signal ON. This signal ON causes the OR logical operator 342c to output the deployment allowance signal ON, which starts at the time t₅.

Then, at the time t₂, where the first acceleration signal is still over the threshold value TH/L, the data information on the first acceleration signal becomes abnormal, and at the time tₐ the data information recovers. The deployment allowance signal is kept ON during this abnormal period DA.

At the time tₐ, the data abnormality judging part 33 judges the data information to be normal, and outputs the data abnormality signal OFF. Accordingly, the deployment allowance signal ON or OFF depends on the level judgment signal from the time tₐ. Since the first acceleration signal is below the threshold value TH/L, the Acceleration level judging part 342a resets the count-time to keep the level judgment signal ON from the time tₐ to the time t₁₀, where a period between the time tₐ to the time t₁₀, corresponds to the latch-time GL. In this case, the first acceleration signal is below the threshold value TH/L between the time tₐ and the time t₁₁, and accordingly the level judgment signal, corresponding to the deployment allowance signal in this state, becomes OFF, as shown in a third part (c) in FIG. 6.

At the time t₇, the deployment signal becomes ON, and accordingly the ignition signal becomes ON. The ignition signal ON ignites the squib of the air-bag deployment device 4 to deploy the air bag for protecting the driver from a crash damage.

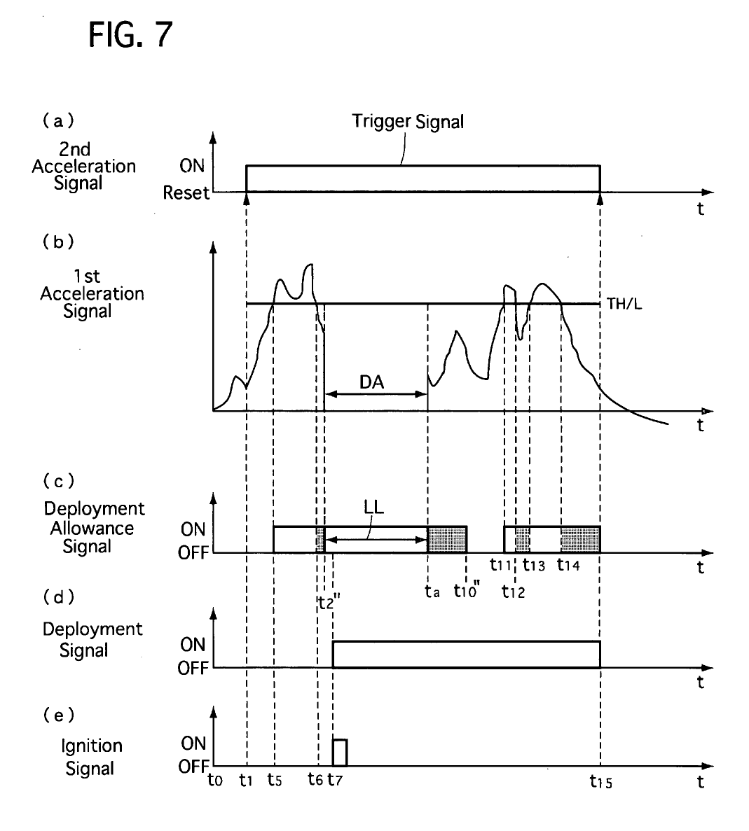

A time chart of a fifth example of the operation of the air-bag deployment system is shown in FIG. 7. In this example, the first acceleration signal is similar to that in FIG. 3 except that the data information becomes abnormal for the period DA from the time t_{2″} to tₐ and then it recovers normal at the time tₐ during the collision. Note that the first acceleration signal exceeds the threshold value TH/L at the time t₅ and falls below the threshold value TH/L at time t₆, then the abnormality of the data information occurring at the time t_{2″}.

At the time t₅, the first acceleration signal exceeds the threshold value TH/L as shown in a second part (b) in FIG. 7, and the acceleration level judging part 342a outputs the level judgment signal ON and starts to count the latch-time.

At the time t₆, although the first acceleration signal falls below the threshold value TH/L, the level judgment signal is kept ON.

At the time t_{2″}, the data abnormality judging part 33 judges the abnormality of the first acceleration signal to output the data abnormality signal ON, and accordingly the deployment allowance signal ON or OFF depends on the level judgment signal. In addition, counting of the latch-time is stopped until the data information becomes normal, and the deployment allowance signal is kept to be ON for a period LL corresponding to that between the time t_{2″} and the time tₐ as shown in a third part (c) in FIG. 7.

At the time tₐ, the latch-time starts to be counted from zero, and the deployment allowance signal is further kept ON from the time tₐ to the time t_{10″}, in other words, for the latch-time GL.

On the other hand, the deployment judging part 341 accumulates the integral value based on the second acceleration signal, and outputs the deployment signal ON at the time t₇. Accordingly the ignition signal becomes ON to ignite the squib of the air-bag deployment device 4 and deploy the air bag for protecting the driver from a crash damage.

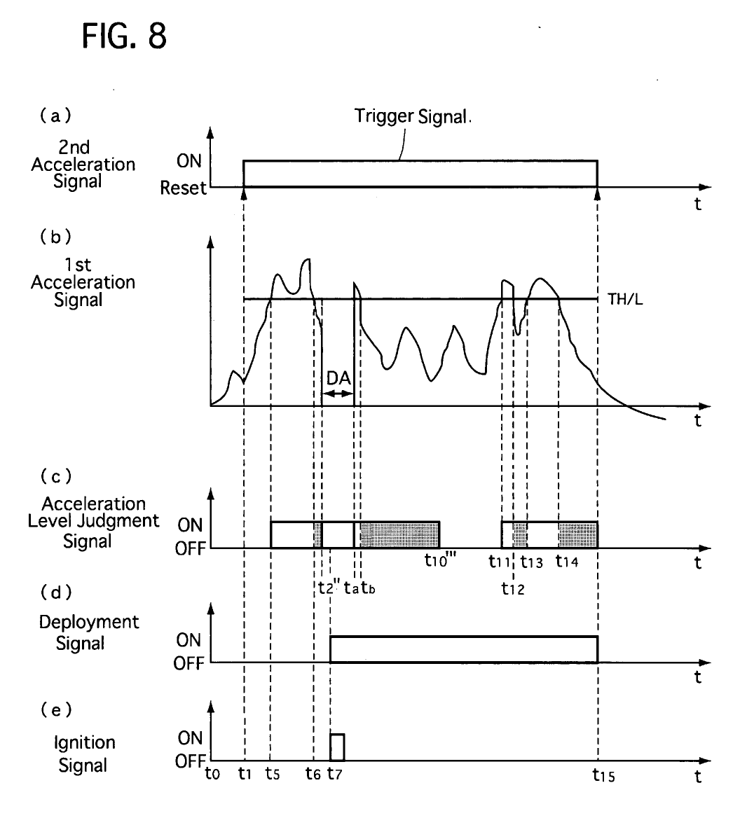

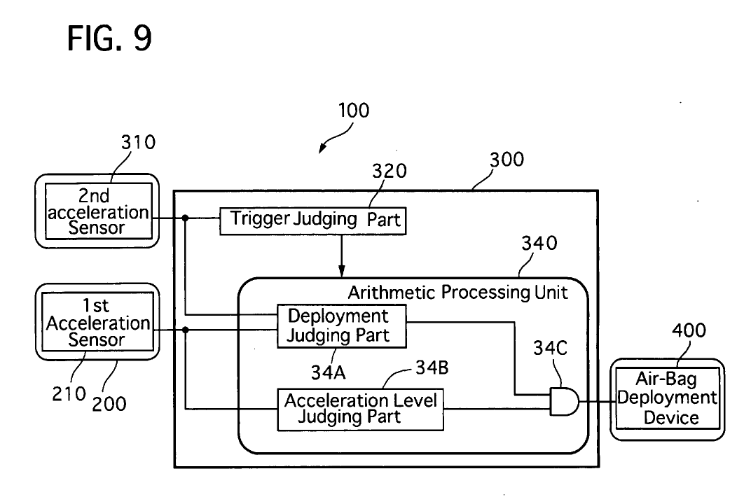

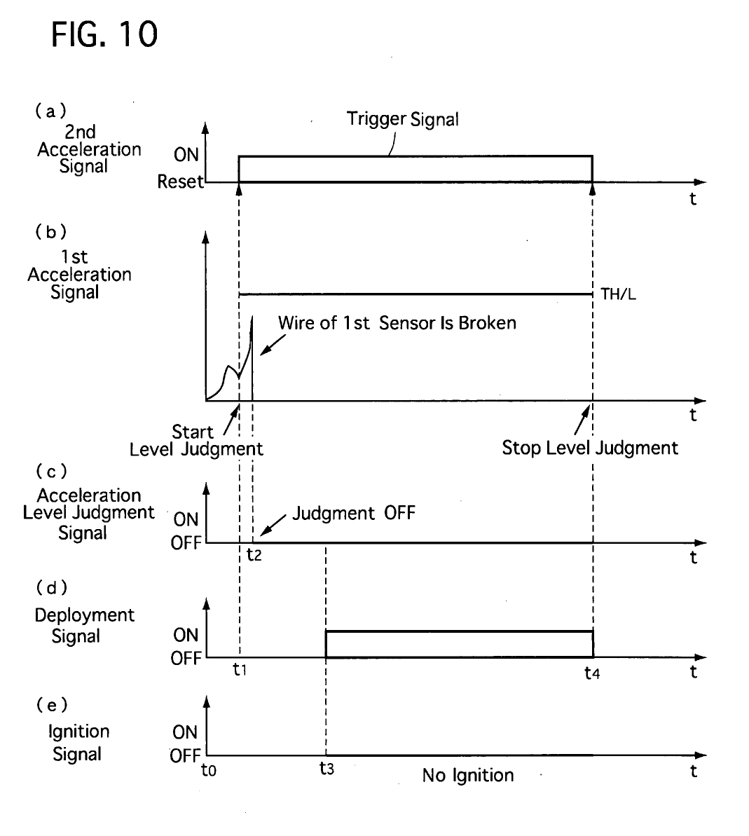

A time chart of a sixth example of the operation of the air-bag deployment system is shown in FIG. 8. In this example, the first acceleration signal is similar to that in FIG. 3 except that the data information becomes abnormal for the period DA from the time t_{2″} to ta and then it recovers normal at the time tₐ during the collision. Note that the first acceleration signal exceeds the threshold value TH/L at the time t₅ and falls below the threshold value TH/L at time t₆, then the abnormality of the data information occurring at the time t_{2″}, which is similar to the operation shown in FIG. 7 except the first acceleration signal being over the threshold value TH/L at the time tₐ.

During the abnormal period DA between the time t_{2″} and the time tₐ, the deployment allowance signal is kept ON as shown in a second part (b) and a third part (c) in FIG. 8.

From the time tₐ to the time t_{b}, the first acceleration signal exceeds the threshold value TH/L, and accordingly the deployment allowance signal is kept ON. The latch-time starts to be counted from the time t_{b}, and the deployment allowance signal becomes OFF at the time t_{10′″}.

On the other hand, the deployment judging part 341 accumulates the integral value based on the second acceleration signal, and outputs the deployment signal ON at the time t₇. Accordingly the ignition signal becomes ON to ignite the squib of the air-bag deployment device 4 and deploy the air bag for protecting the driver from a crash damage.

Therefore, the air-bag deployment system of the embodiment has the following advantages.

In this embodiment, the air-bag deployment device has the data abnormality judging part 33 that outputs a data abnormality signal ON when the data information on the first acceleration signal is judged to be abnormal, and the allowance judging part 342 that outputs the deployment allowance signal ON when it receives the data abnormality signal ON. Therefore, the system can decrease misjudgment on collision as much as possible and increase the opportunity to deploy the air bag in a case of the collision where the data information outputted from the first acceleration sensor, which is provided at the front side portion of the vehicle body, becomes abnormal in the collision.

When the data information recovers during the collision, the deployment allowance signal is shifted to depend on the level judgment signal. This can increase the possibility of the deployment of the air bag.

While there have been particularly shown and described with reference to preferred embodiments thereof, it will be understood that various modifications may be made therein, and it is intended to cover in the appended claims all such modifications as fall within the true spirit and scope of the invention.

The installation of the air-bag deployment device 4 is not limited only in the steering-wheel pad for protecting a driver, and the device 4 may be further installed in an instrument panel for protecting a front-seat passenger and in front-seat back for protecting rear-seat passengers.

The installation of the second acceleration sensor 21 is not limited in the air-bag deployment judging device 2 as shown in the embodiment. It may be installed out of the device 2, as long as it is in the passenger compartment 8.

The entire contents of Japanese Patent Application No. 2006-263728 filed Sep. 28, 2006 are incorporated herein by reference.

What is claimed is:

1. An air-bag deployment system comprising:
a first acceleration sensor that is provided in a front side portion of a vehicle body and detects acceleration to output a first acceleration signal;
a second acceleration sensor that is provided in a passenger compartment and detects acceleration to output a second acceleration signal;
an air-bag deployment judging device that receives the first and second acceleration signals and executes a first deployment judgment that uses primarily the first acceleration signal to output a deployment allowance signal and a second deployment judgment that uses primarily the second acceleration signal to output a deployment signal, the air-bag deployment judging device executing an AND operation of the deployment allowance signal and the deployment signal so that an ignition signal ON is outputted when both of the deployment allowance signal and the deployment signal are ON; and
an air-bag deployment device that receives the ignition signal and deploys an air bag when the ignition signal is ON, wherein
the air-bag deployment device has a data abnormality judging part that monitors the first acceleration signal and outputs a data abnormality signal ON when the data abnormality judging part judges data information on the first acceleration signal to be abnormal, and an allowance judging part that receives the data abnormality signal and outputs the deployment allowance signal ON when the allowance judging part receives the data abnormality signal ON.

2. The air-bag deployment system according to claim 1, wherein
the air-bag deployment device further has a trigger judgment part that receives the second acceleration signal and outputs a trigger signal ON to start the first and second deployment judgments when the second acceleration signal exceeds a predetermined acceleration value.

3. The air-bag deployment system according to claim 2, wherein
the first deployment judgment is executed by an OR operation of a judging result of whether the first acceleration signal exceeds an acceleration threshold value and a judging result based on the data abnormality signal, and
the second deployment judgment is executed by judging based on the second acceleration signal whether a collision occurs.

4. The air-bag deployment system according to claim 3, wherein
the allowance judging part outputs the deployment allowance signal OFF when the data abnormality judging part judges recovery of the data information during the collision.

5. The air-bag deployment system according to claim 4, wherein
the deployment signal is kept ON for latch-time after the first acceleration signal falls below the acceleration threshold value.

6. The air-bag deployment system according to claim 5, wherein
counting the latch-time is stopped when the data information becomes abnormal, and reset when the data information recovers.

7. The air-bag deployment system according to claim 1, wherein
the first deployment judgment is executed by an OR operation of a judging result of whether the first acceleration signal exceeds an acceleration threshold value and a judging result based on the data abnormality signal, and
the second deployment judgment is executed by judging based on the second acceleration signal whether a collision occurs.

8. The air-bag deployment system according to claim 1, wherein
the allowance judging part outputs the deployment allowance signal OFF when the data abnormality judging part judges recovery of the data information during the collision.

9. The air-bag deployment system according to claim 1, wherein
the deployment signal is kept ON for latch-time after the first acceleration signal falls below the acceleration threshold value.

10. The air-bag deployment system according to claim 9, wherein
counting the latch-time is stopped when the data information becomes abnormal, and reset when the data information recovers.

11. An air-bag deployment method comprising:
detecting acceleration to output a first acceleration signal by using a first acceleration sensor provided in a front side portion of a vehicle body;
detecting acceleration to output a second acceleration signal by using a second acceleration sensor provided in a passenger compartment;
receiving the first and second acceleration signals and executing a first deployment judgment that uses primarily the first acceleration signal to output a deployment allowance signal and a second deployment judgment that uses primarily the second acceleration signal to output a deployment signal, by an air-bag deployment judging device;
monitoring the first acceleration signal and outputting a data abnormality signal ON when the data abnormality judging part judges data information on the first acceleration signal to be abnormal, by a data abnormality judging part of the air-bag deployment judging device;
outputting the deployment allowance signal ON when the data abnormality signal is ON; and
executing an AND operation of the deployment allowance signal and the deployment signal so that an ignition signal ON is outputted to an air-bag deployment device when both of the deployment allowance signal and the deployment signal are ON, by the air-bag deployment judging device.

12. The air-bag deployment method according to claim 11, wherein
the air-bag deployment device further has a trigger judgment part that receives the second acceleration signal and outputs a trigger signal ON to start the first and second deployment judgments when the second acceleration signal exceeds a predetermined acceleration value.

13. The air-bag deployment method according to claim 12, wherein
the first deployment judgment is executed by an OR operation of a judging result of whether the first acceleration signal exceeds an acceleration threshold value and a judging result based on the data abnormality signal, and
the second deployment judgment is executed by judging based on the second acceleration signal whether a collision occurs.

14. The air-bag deployment method according to claim 13, wherein
the allowance judging part outputs the deployment allowance signal OFF when the data abnormality judging part judges recovery of the data information during the collision.

15. The air-bag deployment method according to claim 14, wherein
the deployment signal is kept ON for latch-time after the first acceleration signal falls below the acceleration threshold value.

16. The air-bag deployment method according to claim 15, wherein
counting the latch-time is stopped when the data information becomes abnormal, and reset when the data information recovers.

17. The air-bag deployment method according to claim 11, wherein
the first deployment judgment is executed by an OR operation of a judging result of whether the first acceleration signal exceeds an acceleration threshold value and a judging result based on the data abnormality signal, and
the second deployment judgment is executed by judging based on the second acceleration signal whether a collision occurs.

18. The air-bag deployment method according to claim 11, wherein
the deployment allowance signal OFF is outputted when the data abnormality judging part judges recovery of the data information during the collision.

19. The air-bag deployment method according to claim 11, wherein
the deployment signal is kept ON for latch-time after the first acceleration signal falls below the acceleration threshold value.

20. The air-bag deployment method according to claim 19, wherein
counting the latch-time is stopped when the data information becomes abnormal, and reset when the data information recovers.
